(19) United States
(12) Patent Application Publication
(10) Pub. No.: US 2020/0202277 A1
(43) Pub. Date: Jun. 25, 2020

(54) ENHANCED DYNAMIC MONITORING OF ON-DEMAND KEY PERFORMANCE INDICATORS

(71) Applicant: International Business Machines Corporation, Armonk, NY (US)

(72) Inventors: Bo Chen Z Zhu, Xi'an (CN); Jing Yan Ma, Beijing (CN); Fu Li Bian, Beijing (CN); Cheng Fang Wang, Beijing (CN); Yu Ying Wang, Beijing (CN); Peng Fei Tian, Beijing (CN)

(21) Appl. No.: 16/225,616

(22) Filed: Dec. 19, 2018

(51) Int. Cl. G06Q 10/06; G06F 9/50

(52) U.S. Cl. CPC G06Q 10/06393; G06F 2209/5011; G06F 9/5016; G06Q 10/06395

(57) ABSTRACT

An on-demand key performance indicator (KPI) monitoring system includes an on-demand KPI structure module configured to dynamically generate an on-demand data structure of a KPI based on a KPI request input to a user interface. The KPI request includes a one or more targeted KPI objects. An agent collector module generates an on-demand KPI collection strategy based on the on-demand data structure. An object monitoring module collects KPI objects based on the on-demand KPI collection strategy. The collected KPI objects include the targeted KPI objects requested by the user, while excluding non-targeted KPI objects excluded from the user's KPI request.

### BACKGROUND

The present invention generally relates to data processing, and more particularly, to key performance indicator (KPI) processing of information technology infrastructures.

Business performance monitoring (BPM) enables organizations to monitor and respond to changes in the business environment in order to optimize business performance relating to business goals. The business performance is measured by key performance indicators (KPIs) to reflect the outcomes of business activities in an underlying information technology (IT) infrastructure. A KPI is usually defined from a high-level business perspective and is calculated and extracted from information in the data sources of the IT infrastructure. Any transaction activity within the IT infrastructure that potentially affects the resulting KPI is adapted and propagated to the BPM system for further analysis.

### SUMMARY

According to a non-limiting embodiment, an on-demand key performance indicator (KPI) monitoring system comprises an on-demand KPI structure module configured to dynamically generate an on-demand data structure of a KPI based on a KPI request input to a user interface. The KPI request includes at least one targeted KPI object. An agent collector module is configured to generate an on-demand KPI collection strategy based on the on-demand data structure. An object monitoring module is configured to collect KPI objects based on the on-demand KPI collection strategy. The KPI objects collected by the object monitoring module include the at least one targeted KPI object while excluding non-targeted KPI objects excluded from the KPI request.

According to another non-limiting embodiment, a method of performing enhanced dynamic monitoring of on-demand KPIs is provided according to a non-limiting embodiment. The method comprises receiving a KPI request including at least one targeted KPI object, and dynamically generating, via an on-demand KPI structure module, an on-demand data structure of a KPI based on the KPI request. The method further comprises generating, via an agent collector module, an on-demand KPI collection strategy based on the on-demand data structure; and collecting, via an object monitoring module, KPI objects based on the on-demand KPI collection strategy. As a result, the collected KPI objects include the at least one targeted KPI object while excluding non-targeted KPI objects excluded from the KPI request.

According to yet another non-limiting embodiment, a computer readable storage medium has program instructions embodied therewith. The program instructions are executable by a computer processor to cause the computer processor to perform a method of performing enhanced dynamic monitoring of on-demand key performance indicators (KPIs). The method comprises receiving a KPI request including at least one targeted KPI object, and dynamically generating, via an on-demand KPI structure module, an on-demand data structure of a KPI based on the KPI request. The method further comprises generating, via an agent collector module, an on-demand KPI collection strategy based on the on-demand data structure; and collecting, via an object monitoring module, KPI objects based on the on-demand KPI collection strategy, wherein the collected KPI objects include the at least one targeted KPI object while excluding non-targeted KPI objects excluded from the KPI request.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to a non-limiting embodiment;

FIG. 2 depicts abstraction model layers according to a non-limiting embodiment;

FIG. 3 depicts a system configured to perform enhanced dynamic monitoring of on-demand KPIs according to a non-limiting embodiment; and

FIG. 4 depicts an on-demand KPI monitoring system according to a non-limiting embodiment; and

FIG. 5 is a flow diagram illustrating a method of performing enhanced dynamic monitoring of on-demand KPIs.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, KPI monitoring plays important role in establishing the IT infrastructure utilized to measure business performance. To provide a valuable monitoring product to customer or business client, as many KPIs may require monitoring as possible. Current KPI monitoring systems monitor several KPIs, which are divided into different pre-defined static KPI tables (sometimes referred to as KPI groups). The data of KPIs in the same group are then batch collected. As the monitoring scope of customer demands increases, however, system resources are wasted due to the collection of superfluous indicators. In addition, because the KPI tables are pre-defined and static (i.e., are not user-defined), KPIs which are not needed by the client are still be collected by an agent even when a customer requests only selected number of KPIs from the KPI table.

One or more embodiments of the invention address the above-described shortcomings of the prior art by providing a computer system configured to perform enhanced dynamic monitoring of on-demand KPIs. Rather than static KPI tables, the computer system described herein implements a KPI data pool that is in signal communication with a KPI analyzer controller (hereinafter referred to as a KPI analyzer). The KPI data pool and KPI analyzer work together to dynamically generate a data structure of on-demand targeted KPIs. In at least one embodiment, the particular KPIs targeted by different customers at a given time can be loaded by scanning a customized user interface or receiving a targeted KPI request from a user interface operated by a user. The user interface is operated by a given customer, and allows them to select which KPIs to target for monitoring. Then obtained from the KPI pool, the targeted KPIs selected by a customer are generated, while excluding non-targeted KPIs that were not selected or indicated by the user via the user interface. The KPI monitoring agent is then automatically updated, and operates to collect the targeted KPIs while excluding non-targeted KPIs (i.e., KPIs not selected by the user). In this manner, the system resources are greatly enhanced, processing efficiency is improved, and business performance accuracy is increased.

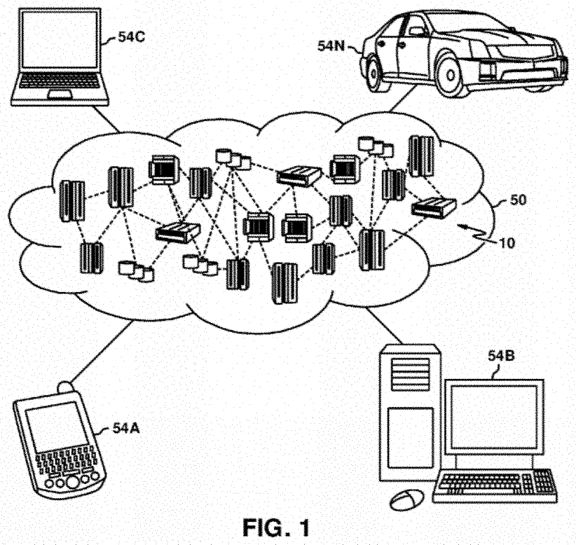

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

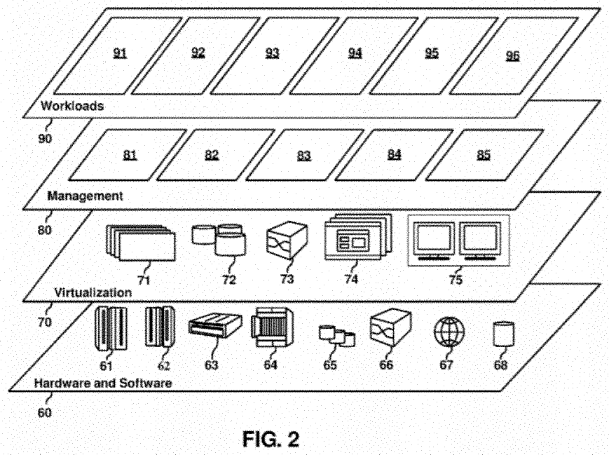

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 include hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and an autonomous vehicle schedule processing 96.

The methods described herein can be implemented in software (e.g., firmware), hardware, or a combination thereof. In exemplary embodiments, the methods described herein are implemented in software, as an executable program, and is executed by one or more special controllers operated using various computing devices including, but not limited to, a personal computer, workstation, minicomputer, or mainframe computer. The system 100, therefore, includes general-purpose computer 101.

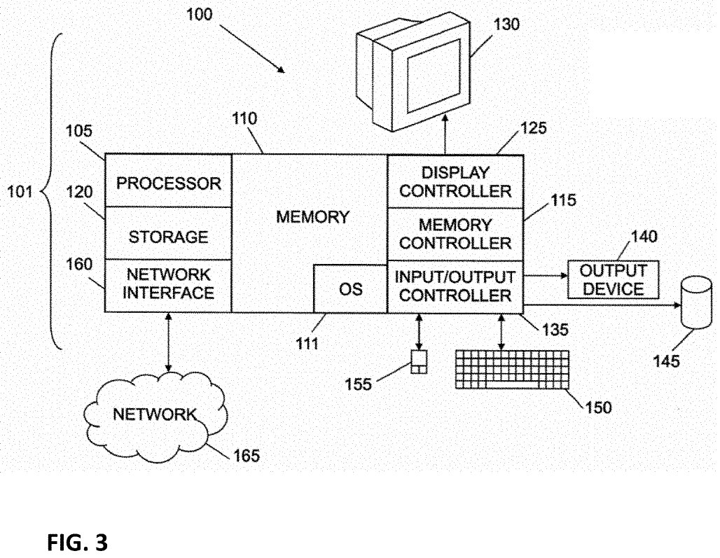

In exemplary embodiments, in terms of hardware architecture, as shown in FIG. 3, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 3, the software in the memory 110 includes the inferential business process monitoring methods described herein in accordance with exemplary embodiments and a suitable operating system (OS) 111. The operating system 111 essentially controls the execution of other computer programs, such the inferential business process monitoring systems and methods described herein, and provides scheduling, input-output control, file and data management, memory management, and communication control and related services.

The inferential business process monitoring methods described herein may be in the form of a source program, executable program (object code), script, or any other entity comprising a set of instructions to be performed. When a source program, then the program needs to be translated via a compiler, assembler, interpreter, or the like, which may or may not be included within the memory 110, so as to operate properly in connection with the OS 111. Furthermore, the inferential business process monitoring methods can be written as an object-oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example, but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The inferential business process monitoring methods described herein and the OS 111, in whole or in part, but typically the latter, are read by the processor 105, perhaps buffered within the processor 105, and then executed.

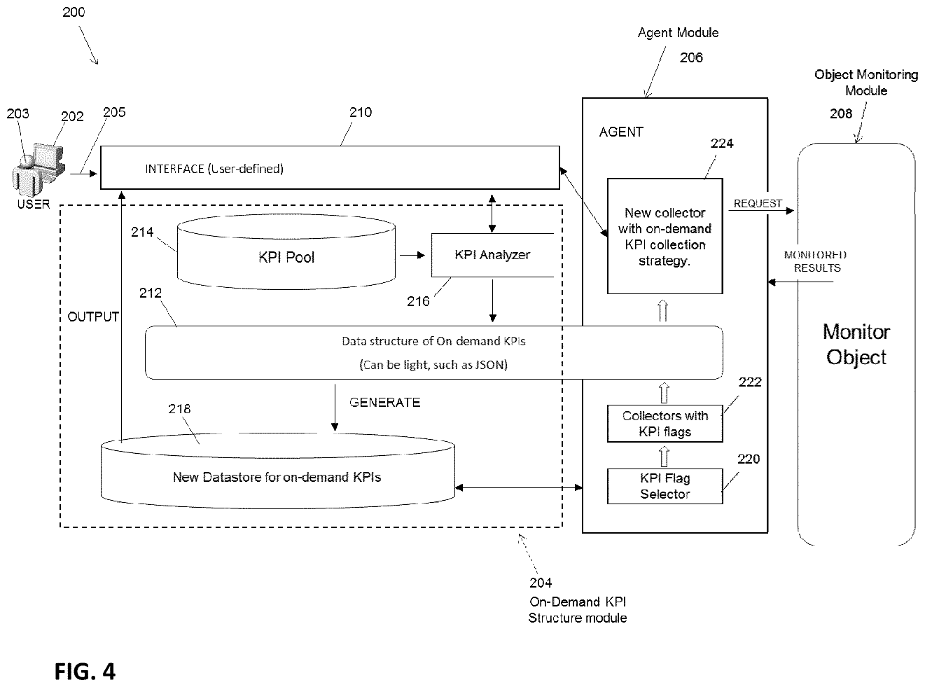

With reference to now FIG. 4, an on-demand KPI monitoring system 200 is illustrated according to a non-limiting embodiment. The on-demand KPI monitoring system 200 is configured to perform enhanced dynamic monitoring of on-demand KPIs. Unlike conventional KPI monitoring systems, which employ pre-defined static KPI tables, the on-demand KPI monitoring system 200 described herein allows a user or customer to dynamically request one or more targeted KPI objects to be monitored, while excluding non-targeted from being monitored.

The on-demand KPI monitoring system includes a user terminal 202 (sometimes referred to as a client station), an on-demand KPI structure module 204, an agent collector module 206, and an object monitoring module 208. The user terminal 202 can be implemented using various computing devices including, but not limited to, a personal computer, a workstation, a minicomputer, a mainframe computer, a tablet computer, a smartphone, or any other wireless terminal device. Any one of the on-demand KPI structure module 204, the agent collector module 206, and the object monitoring module 208 can be constructed as one or more electronic hardware controllers that includes memory and a processor configured to execute algorithms and computer-readable program instructions stored in the memory.

The user terminal 202 is capable of exchanging data with the on-demand KPI structure module 204 and/or the agent collector module 206 via a user interface 210. The user interface 210 can be displayed on the user terminal 202, which in turn can be manipulated by a user 203.

In at least one embodiment, the user interface 210 receives a target KPI request 205 input by the user 203 via the user terminal 202. Accordingly, the user interface 202 can indicate (e.g., display and store in a data file and/or cache) one or more targeted KPI objects that is desired by the user 203 based on the target KPI request 205. The remaining KPI objects that are not included in the target KPI request 205 (e.g., not selected by the user) can be determined as non-targeted KPI objects and indicated as such by the user interface 210. In at least one embodiment, the user interface 210 generates an on-demand KPI definition data file indicating the targeted KPI object(s) and the non-targeted KPI objects.

The on-demand KPI structure module 204 is configured to dynamically generate an on-demand data structure 212 of one or more targeted KPIs based on the target KPI request 205 input to the user interface 202 (e.g., by the user 203). The on-demand KPI structure module 204 includes a KPI storage pool 214, a KPI analyzer controller 216, and an on-demand KPI data storage unit 218.

The KPI storage pool 214 is configured to store a plurality of different KPIs. The KPI storage pool also stores KPI metadata corresponding to a given KPI among the different stored KPIs. The metadata includes at least one attribute such as, for example, a name of the given KPI, a KPI identifier (ID) of the given KPI, and/or a collector configured to collect the given KPI. A description of the collector is presented in greater detail below.

In at least one embodiment, the KPIs are organized as a group in a lookup table (LUT), which is then stored in the KPI storage pool 214. In this scenario, the KPI storage pool 214 can select each KPI with a required parameter defined in metadata, and store the selected KPI in any light weight format such as, for example, JavaScript Object Notation (JSON), Extensible Markup Language (XML), etc. At times, there may be a need to update with the KPI storage pool 214 with a new KPI when, for example, the monitor object has changed or has been updated. When this scenario occurs, a user can determine the parameter defined in the metadata, organize the new KPI in the same format, and add the new KPI into the KPI storage pool 214.

The KPI analyzer controller 216 is configured to determine at least one targeted KPI from among the plurality of KPIs stored in the KPI storage pool 214 based on the target KPI request 205. For example, KPI analyzer 216 can process the on-demand KPI definition data file to determine which KPI objects were selected by the user 203 to be targeted KPI object(s) compared to which KPIs were not selected, and thus determined by the user to be non-targeted KPI objects. Accordingly, the KPI analyzer controller 216 can generate the on-demand data structure 212 that includes the targeted KPI objects, while excluding the non-targeted KPI objects from the on-demand data structure 212.

The on-demand KPI data storage unit 218 is in signal communication with the KPI analyzer controller 216 to receive and store the on-demand data structure 212. The on-demand data structure 212 stored in the on-demand KPI data storage unit 218 can then be made available for access by the agent collector module 206 for generating an on-demand KPI collection strategy as described in greater detail below.

The on-demand KPI data storage unit 218 is also in signal communication with the agent collector module 206 and the interface 210. Accordingly, the on-demand KPI data storage unit 218 can store monitored results received from the agent collector module 206 and/or output one or more monitored results to the interface 210. For example, when a user utilizes the interface 210 to input a KPI request to target a transaction rate, the object monitoring module 208 will monitor the transactions and provide the transaction rate. The monitoring results will be provided to the agent collector module 206, which in turn will provide them to the on-demand data structure 212 where the monitored results are stored. The on-demand data structure 212 can also output the monitored results to the interface 210, which will indicate the value of transaction rate in each sampling monitored by the object monitoring module 208. Accordingly, the interface 210 can display or graphically illustrate the targeted transaction rate to the end user controlling the client station 202.

The agent collector module 206 includes a KPI flag selector 220, one or more KPI collectors 222, and a collection strategy controller 224. Any one of the KPI flag selector 220, KPI collector 222, and collection strategy controller 224 can be constructed as one or more electronic hardware controllers that include memory and a processor configured to execute algorithms and computer-readable program instructions stored in the memory.

The KPI flag selector 220 is in signal communication with the on-demand KPI data storage unit 218. Accordingly, the KPI flag selector 220 can determine one or more targeted KPI requested by the user 203 based on the on-demand data structure 212 stored in the on-demand KPI data storage unit 218. Based on the data structure 212, the KPI flag selector 220 can determine which collector(s) 222 should be activated in order to collect a respective targeted KPI requested by the user. In this manner, the KPI flag selector 220 can generate one or more KPI flag activation signals for activating a respective collector 222.

Each KPI collector 222 is selectively activated or deactivated in response to receiving a KPI flag activation signal from the KPI flag selector 220. In this manner, only the collectors 222 responsible for collecting the target KPIs requested by the user 203 are activated, while the remaining collectors responsible for collecting non-targeted KPIs are deactivated. This operation facilitates the system's ability to dynamically filter (e.g. eliminate) superfluous KPI collections from the monitoring results.

The collection strategy controller 224 is in signal communication with the collectors 222. Accordingly, the collection strategy controller 224 generates an on-demand collection strategy based on which collectors 222 are activated to collect the targeted KPIs. The on-demand collection strategy is then delivered to the object monitoring module 208 and serves a request for monitoring objects corresponding to the targeted KPIs.

The object monitoring module 208 receives the object monitoring request indicating which target KPIs have been requested to be monitored by the user 203. Unlike conventional KPI monitoring systems where an object monitoring module monitors all KPIs defined by a static KPI table, the object monitoring module 208 described herein monitors the target KPI objects dynamically requested by the user 203, while disregarding any non-targeted KPI objects. In this manner, superfluous results and “noise” are effectively filtered and eliminated from the monitoring results. The monitoring results can then be returned to the agent collector module 206 and delivered to the client station 202 via the interface 210.

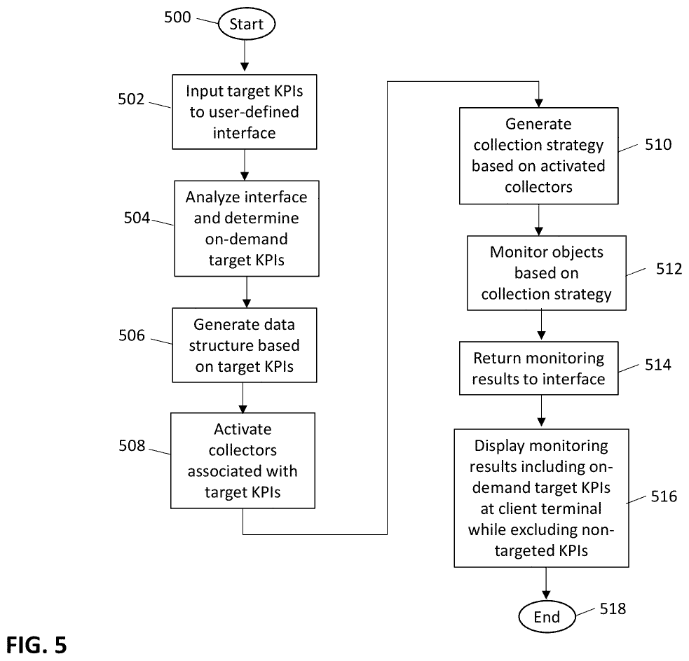

Turning to FIG. 5, a method of performing enhanced dynamic monitoring of on-demand KPIs is illustrated according to a non-limiting embodiment. The method begins at operation 500, and at operation 502 one or more input target KPIs are dynamically input to an interface facilitating data exchange between a client terminal, an on-demand KPI structure module 204, and an agent collector module 206. The target KPIs can be input by a user operating the client terminal, for example, and can dynamically change on an on-demand basis (i.e., according to what the user desires at given point in time). At operation 504, the on-demand KPI structure module 204 analyzes the interface and the inputs provided by the user, and determines the target KPIs. At operation 506, a KPI data structure is generated based on the on-demand target KPIs.

At operation 508, the collector(s) included with the agent collector module 206 responsible for collecting a corresponding target KPI indicated in the data structure is activated. At operation 510, a collection strategy is generated based on the activated collector(s). At operation 512, objects corresponding to the target KPIs defined by the collection strategy are monitored. At operation 514, the monitoring results are returned to interface and the monitoring results are displayed at the client terminal allowing a user to monitor and analyze the monitoring results. Accordingly, method ends at operation 518 with the user being provided the requested target KPIs without needed to parse through non-targeted KPI data. In this manner, the method described herein can exclude non-targeted KPIs thereby dynamically filter (e.g. eliminate) superfluous KPI collections from the monitoring results, providing a user with more desirable and streamlined results.

As described herein, various non-limiting embodiments provide a KPI monitoring system that performs enhanced dynamic monitoring of on-demand KPIs. Rather than static KPI tables, the KPI monitoring system described herein implements a KPI data pool that is in signal communication with a KPI analyzer controller (hereinafter referred to as a KPI analyzer). The KPI data pool and KPI analyzer work together to dynamically generate a data structure of on-demand targeted KPIs. In at least one embodiment, the particular KPIs targeted by different customers at a given time can be loaded by scanning a customized user interface or receiving a targeted KPI request from a user interface operated by a user. The user interface is operated by a given customer and allows them to select which KPIs to target for monitoring. The KPI monitoring system generates a collection strategy based on the target KPIs while omitting non-targeted KPIs from the collection strategy. Accordingly, the monitored objects correspond to the on-demand targeted KPIs while excluding the non-targeted KPIs. In this manner, the KPI monitoring system can dynamically filter (e.g. eliminate) superfluous KPI collections from the monitoring results presented to a user. Because the system does not waste resources and memory monitoring and collecting excess non-targeted data, the performance and operation of the system is significantly improved.

The methods can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The inferential business process monitoring methods described herein can be embodied in any computer-readable medium for use by or in connection with an instruction execution system, apparatus, or device, such as a computer-based system, processor containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the inferential business process monitoring methods are implemented in hardware, the inferential business process monitoring methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. An on-demand key performance indicator (KPI) monitoring system comprising:
an on-demand KPI structure module configured to dynamically generate an on-demand data structure of a KPI based on a KPI request input to a user interface, the KPI request including at least one targeted KPI object;
an agent collector module that generates an on-demand KPI collection strategy based on the on-demand data structure; and
an object monitoring module configured to collect KPI objects based on the on-demand KPI collection strategy, the collected KPI objects including the at least one targeted KPI object while excluding non-targeted KPI objects excluded from the KPI request.

2. The on-demand KPI monitoring system of claim 1, wherein the on-demand KPI structure module comprises:
a KPI storage pool configured to store a plurality of different KPIs;
a KPI analyzer controller configured to obtain at least one targeted KPI from among the plurality of KPIs stored in the KPI storage pool, and to generate the on-demand data structure of a KPI based on the obtained at least one targeted KPI; and
an on-demand KPI data storage unit in signal communication with the KPI analyzer controller, the on-demand KPI data storage unit configured to store the on-demand data structure of a KPI received from the KPI analyzer controller.

3. The on-demand KPI monitoring system of claim 2, wherein the KPI storage pool stores KPI metadata corresponding to a given KPI among the plurality of different KPIs, the metadata including at least one attribute selected from the group comprising a name of the given KPI, a KPI identifier (ID) of the given KPI, and a collector configured to collect the given KPI.

4. The on-demand KPI monitoring system of claim 2, wherein the agent collector module comprises:
a KPI flag selector in signal communication with the on-demand KPI data storage unit, the KPI flag selector configured to determine the at least one targeted KPI based on the on-demand data structure stored in the on-demand KPI data storage unit and to generate at least one KPI flag activation signal;
a plurality of KPI collectors that are selectively activated or deactivated based on the at least one KPI flag activation signal received from the KPI flag selector; and
a collection strategy controller that generates the on-demand collection strategy based on at least one activated KPI collector among the plurality of KPI collectors.

5. The on-demand KPI monitoring system of claim 1, further comprising a user terminal configured to exchange data with one or both of the on-demand KPI structure module and the agent collector module.

6. The on-demand KPI monitoring system of claim 5, wherein the user interface is displayed at the user terminal and receives the KPI request via the user terminal.

7. The on-demand KPI monitoring system of claim 6, wherein the user interface indicates the at least one targeted KPI object and the non-targeted KPI objects, and generates an on-demand KPI definition data file indicating the at least one targeted KPI object and the non-targeted KPI objects.

8. The on-demand KPI monitoring system of claim 7, wherein the on-demand KPI structure module generates the on-demand data structure based on the at least one targeted KPI object and the non-targeted KPI objects indicated by the on-demand KPI definition data file.

9. A method of performing enhanced dynamic monitoring of on-demand key performance indicators (KPIs), the method comprising:
receiving a KPI request including at least one targeted KPI object;
dynamically generating, via an on-demand KPI structure module, an on-demand data structure of a KPI based on the KPI request;
generating, via an agent collector module, an on-demand KPI collection strategy based on the on-demand data structure; and
collecting, via an object monitoring module, KPI objects based on the on-demand KPI collection strategy,
wherein the collected KPI objects include the at least one targeted KPI object while excluding non-targeted KPI objects excluded from the KPI request.

10. The method of claim 9, further comprising:
storing, via a KPI storage pool, a plurality of different KPIs;
obtaining, via a KPI analyzer controller, at least one targeted KPI from among the plurality of KPIs stored in the KPI storage pool;
generating, via the KPI analyzer controller, the on-demand data structure of the KPI based on the obtained at least one targeted KPI; and
storing, via an on-demand KPI data storage unit, the on-demand data structure of a KPI received from the KPI analyzer controller.

11. The method of claim 10, further comprising storing, via the KPI storage pool, KPI metadata corresponding to a given KPI among the plurality of different KPIs, the metadata including at least one attribute selected from the group comprising a name of the given KPI, a KPI identifier (ID) of the given KPI, and a collector configured to collect the given KPI.

12. The method of claim 10, further comprising:
determining, via a KPI flag selector, the at least one targeted KPI based on the on-demand data structure stored in the on-demand KPI data storage unit;
generating, via the KPI flag selector, at least one KPI flag activation signal;
selectively activating or deactivating a plurality of KPI collectors based on the at least one KPI flag activation signal received from the KPI flag selector; and
generating, via a collection strategy controller, the on-demand collection strategy based on at least one activated KPI collector among the plurality of KPI collectors.

13. The method of claim 9, further comprising exchanging data between a user terminal and one or both of the on-demand KPI structure module and the agent collector module.

14. The method of claim 13, further comprising displaying a user interface at the user terminal and receiving the KPI request via the user terminal.

15. The method of claim 14, further comprising indicating, via the user interface, the at least one targeted KPI object and the non-targeted KPI objects; and
generating an on-demand KPI definition data file indicating the at least one targeted KPI object and the non-targeted KPI objects.

16. The method of claim 15, further comprising generating, via the on-demand KPI structure module, the on-demand data structure based on the at least one targeted KPI object and the non-targeted KPI objects indicated by the on-demand KPI definition data file.

17. A computer program product comprising a computer readable storage medium having program instructions embodied therewith, the program instructions executable by a computer processor to cause the computer processor to perform a method of performing enhanced dynamic monitoring of on-demand key performance indicators (KPIs), the method comprising:
receiving a KPI request including at least one targeted KPI object;
dynamically generating, via an on-demand KPI structure module, an on-demand data structure of a KPI based on the KPI request;
generating, via an agent collector module, an on-demand KPI collection strategy based on the on-demand data structure; and
collecting, via an object monitoring module, KPI objects based on the on-demand KPI collection strategy,
wherein the collected KPI objects include the at least one targeted KPI object while excluding non-targeted KPI objects excluded from the KPI request.

18. The computer program product claim 17, further comprising:
storing, via a KPI storage pool, a plurality of different KPIs;
obtaining, via a KPI analyzer controller, at least one targeted KPI from among the plurality of KPIs stored in the KPI storage pool;
generating, via the KPI analyzer controller, the on-demand data structure of the KPI based on the obtained at least one targeted KPI; and
storing, via the on-demand KPI data storage unit, the on-demand data structure of a KPI received from the KPI analyzer controller.

19. The computer program product claim 18, further comprising storing, via the KPI storage pool, KPI metadata corresponding to a given KPI among the plurality of different KPIs, the metadata including at least one attribute selected from the group comprising a name of the given KPI, a KPI identifier (ID) of the given KPI, and a collector configured to collect the given KPI.

20. The computer program product claim 18, further comprising:
determining, via a KPI flag selector, the at least one targeted KPI based on the on-demand data structure stored in the on-demand KPI data storage unit;
generating, via the KPI flag selector, at least one KPI flag activation signal;
selectively activating or deactivating a plurality of KPI collectors based on the at least one KPI flag activation signal received from the KPI flag selector; and
generating, via a collection strategy controller, the on-demand collection strategy based on at least one activated KPI collector among the plurality of KPI collectors.
